(19) United States
(12) Patent Application Publication
(10) Pub. No.: US 2017/0365901 A1
(43) Pub. Date: Dec. 21, 2017

(54) WARM-UP APPARATUS FOR FUEL CELL FOR VEHICLE

(71) Applicant: MITSUBISHI JIDOSHA KOGYO KABUSHIKI KAISHA, Tokyo (JP)

(72) Inventors: Yusuke HIRAMITSU, Tokyo (JP); Kazuyoshi NAKANE, Tokyo (JP); Keisuke TASHIRO, Tokyo (JP)

(73) Assignee: MITSUBISHI JIDOSHA KOGYO KABUSHIKI KAISHA, Tokyo (JP)

(21) Appl. No.: 15/471,099

(22) Filed: Mar. 28, 2017

(30) Foreign Application Priority Data
Jun. 17, 2016 (JP) 2016-121032

(51) Int. Cl. H01M 16/00; H01M 10/613; H01M 10/625; H01M 10/6568; H01M 8/04858; H01M 8/04746; H01M 8/04029; B60L 11/18; H02J 7/00; B60K 11/04; H01M 8/1018

(52) U.S. Cl. CPC H01M 16/006; H02J 7/0021; H01M 10/613; H02J 7/0003; H01M 10/625; H01M 10/6568; B60K 11/04; H01M 8/04932; H01M 8/04753; H01M 8/04029; B60L 11/1894; B60L 11/1892; B60L 11/1874; B60L 2240/545; H01M 2008/1095; H01M 2250/20; H01M 2250/402

(57) ABSTRACT

Provided is a warm-up apparatus for a fuel cell for an electrically driven vehicle in which a fuel cell and a secondary battery are mounted as power sources of a motor for travelling, and which, when charging of the secondary battery is required, stops operation of the fuel cell and charges the secondary battery with electric power from an external power source by means of a battery charger. The warm-up apparatus includes: a secondary battery cooling circuit that cools the secondary battery; a fuel cell cooling circuit that cools the fuel cell; a connection passage that connects the secondary battery cooling circuit and the fuel cell cooling circuit through a switching valve; and a warm-up control unit that, during charging of the secondary battery, controls the switching valve so that the secondary battery cooling circuit and the fuel cell cooling circuit communicate through the connection passage.

### BACKGROUND OF THE INVENTION

### Field of the Invention

The present invention relates to a warm-up apparatus for a fuel cell for a vehicle in which a fuel cell and a secondary battery are mounted as power sources of a motor for travelling.

### Description of the Related Art

As awareness with respect to environmental issues in recent years increases, fuel cell systems are attracting attention as one kind of system for clean energy generation that does not rely on fossil fuels. For example, a polymer electrolyte fuel cell is used in a fuel cell system that is mounted in a vehicle. The polymer electrolyte fuel cell is built by forming an MEA by bonding a fuel electrode that carries platinum (Pt) as a catalyst and an air electrode on either side of a polymer electrolyte membrane, and stacking a large number of single cells in each of which the MEA is sandwiched by gas diffusion layers and separators. Humidity-regulated fuel gas is supplied to the fuel electrode and humidity-regulated air is supplied to the air electrode, and by this means a power generation reaction proceeds in the catalyst layers of the fuel electrode and the air electrode, and power generation of the fuel cell is started.

In some cases, such a fuel cell system is mounted in an electrically driven vehicle and used together with a secondary battery as power sources of a motor serving as a power source for travelling. For example, electric power is supplied from the secondary battery to the motor of the electrically driven vehicle, and the fuel cell system fulfills a function as a range extender that mainly charges the secondary battery, and the output power thereof is also utilized in an auxiliary manner to drive the motor. When the SOC (state of charge) of the secondary battery decreases as a result of supplying power to the motor it is necessary to charge the secondary battery at a charging station or the like, and operation of the fuel cell is stopped while the secondary battery is being charged. When operation of the fuel cell is stopped, the temperature of the fuel cell gradually decreases and if the temperature thereof falls to less than the rated temperature is it necessary to warm up the fuel cell. There is thus the problem that time is required until the fuel cell is restored to the rated temperature and the rated power output after restarting, and the fuel cell cannot respond immediately with respect to providing a required output.

As a measure to overcome the above problem, for example, according to technology disclosed in Patent Literature (Japanese Patent Laid-Open No. 2007-213942), an air-conditioning system and a cooling circuit of a fuel cell that are mounted in an electrically driven vehicle are connected through a heat exchanger, and the fuel cell is warmed up by causing the air-conditioning system to function as a heat pump cycle by means of electric power from an external power source.

However, according to the technology in the aforementioned Patent Literature, because an electric power supply from an external power source is required, not only is there a problem in terms of the operating cost, but it is also necessary to keep the electrically driven vehicle parked for an additional time after charging of the secondary battery is completed until the warming up of the fuel cell finishes, and there is thus also the problem that the start of travel of the vehicle is delayed. In addition, the heat quantity obtained by the capacity of an air-conditioning system whose original purpose is to perform air conditioning within the cabin of a vehicle is inadequate, and the fuel cell cannot be warmed up quickly, and this is also the cause of a delay in starting travel of the vehicle. Therefore, it is difficult to say that the technology disclosed in the aforementioned Patent Literature is realistic, and originally there has been a demand for a more fundamental solution.

### SUMMARY OF THE INVENTION

An object of the present invention is to provide a warm-up apparatus for a fuel cell for a vehicle, that is excellent in terms of operating cost and that can rapidly warm up a fuel cell and enable the early start of vehicle travel.

To achieve the aforementioned object, the present invention is a warm-up apparatus for a fuel cell for an electrically driven vehicle in which a fuel cell and a secondary battery are mounted as power sources of a motor for travelling, and which, when charging of the secondary battery is required, stops operation of the fuel cell and charges the secondary battery with electric power from an external power source by means of a battery charger, including: a secondary battery cooling circuit that cools the secondary battery; a fuel cell cooling circuit that cools the fuel cell; a connection passage that connects the secondary battery cooling circuit and the fuel cell cooling circuit through a switching valve; and a warm-up control unit that, during charging of the secondary battery, controls the switching valve so that the secondary battery cooling circuit and the fuel cell cooling circuit communicate through the connection passage.

According to the warm-up apparatus for a fuel cell for a vehicle configured as described above, a coolant is heated by a secondary battery in a secondary battery cooling circuit, and the coolant is transferred to a fuel cell cooling circuit through a connection passage to thereby warm up the fuel cell. Because the fuel cell is warmed up by heat that the secondary battery generates while charging, operating costs are not required, and furthermore because the secondary battery that is being charged generates a large amount of heat and warming up of the fuel cell can be performed concurrently with charging of the secondary battery, warming up of the fuel cell can be completed while the secondary battery is being charged.

Thus, the warm-up apparatus for a fuel cell for an electrically driven vehicle according to the present invention is excellent in terms of operating cost, and can rapidly warm up a fuel cell and enable the early start of vehicle travel.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 is an overall configuration diagram illustrating an electrically driven vehicle in which a warm-up apparatus for a fuel cell according to an embodiment of the present invention is mounted;

FIG. 2 is a circuit diagram illustrating circuitry for warming up the fuel cell; and

FIG. 3 is a flowchart illustrating a warm-up control routine which a vehicle ECU executes.

### DETAILED DESCRIPTION OF THE INVENTION

Hereunder, one embodiment of a warm-up apparatus for a fuel cell for a vehicle that embodies the present invention is described.

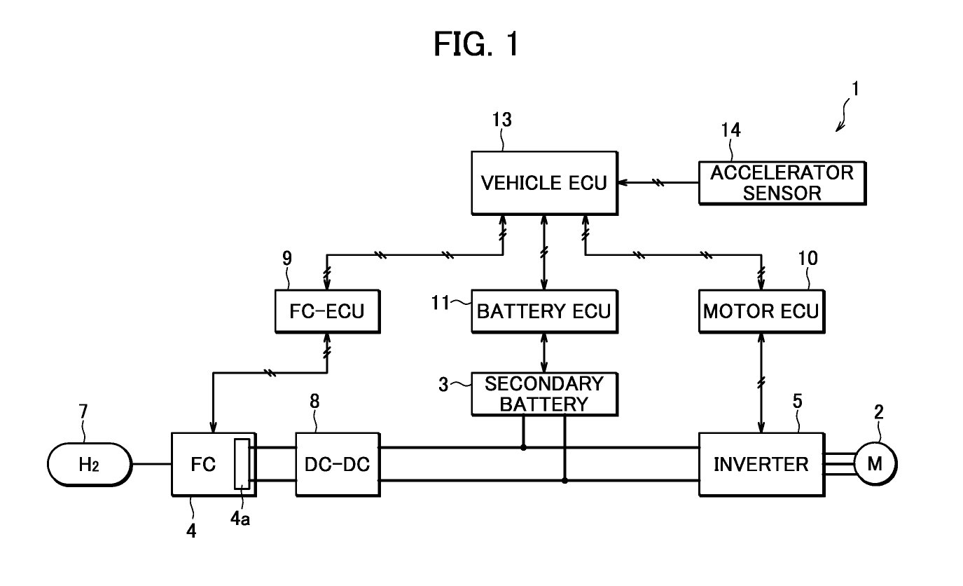

FIG. 1 is an overall configuration diagram illustrating an electrically driven vehicle in which the warm-up apparatus for a fuel cell of the present embodiment is mounted.

An electrically driven vehicle 1 of the present embodiment is a hybrid fuel cell vehicle that includes a motor 2 as a power source for travelling and also includes a secondary battery 3 and a fuel cell system 4 as power sources of the motor 2. As is widely known, the secondary battery 3 is an electric battery that is capable of charging and discharging direct current electric power by means of a chemical reaction, and the fuel cell system 4 is a system that generates electric power by an electrochemical reaction using hydrogen gas in a fuel cell 4a. Basically, the motor 2 is driven by electric power from the secondary battery 3, and the fuel cell system 4 mainly fulfills a function as a range extender that charges the secondary battery 3, and the output power thereof is also utilized in an auxiliary manner to drive the motor 2.

The secondary battery 3 is connected through an inverter 5 to the motor 2, and the inverter 5 performs a function of converting between direct current and alternating current. That is, during power running control of the motor 2, direct current electric power from the secondary battery 3 or the fuel cell system 4 is converted to three-phase AC electric power by the inverter 5 to drive the motor 2, and during regenerative control of the motor 2, three-phase AC electric power from the motor 2 is converted to direct current electric power by the inverter 5 to charge the secondary battery 3.

The fuel cell system 4 is connected to the secondary battery 3 and the inverter 5. The polymer electrolyte fuel cell 4a provided in the fuel cell system 4 is built by forming an MEA (Membrane Electrode Assembly) by bonding a fuel electrode (anode) that carries platinum (Pt) as a catalyst and an air electrode (cathode) on either side of a polymer electrolyte membrane, and stacking a large number of single cells in each of which the MEA is sandwiched by gas diffusion layers and separators.

The operating principles of the fuel cell 4a are widely known and therefore will not be described in detail here. In general, however, the fuel cell 4a operates as a result of hydrogen gas from a hydrogen tank 7 that is subjected to humidity regulation being supplied to the fuel electrode, and humidity-regulated air being supplied to the air electrode. The hydrogen gas supplied to the fuel electrode is split into hydrogen ions and electrons by catalytic action, and the hydrogen ions then pass through the polymer electrolyte membrane to reach the air electrode, while the electrons reach the air electrode via an unshown external circuit, and by this means a direct-current voltage is generated with the fuel electrode as negative and the air electrode as positive. Further, at the air electrode, air supplied through an air supply line, hydrogen ions that passed through the polymer electrolyte membrane and electrons that arrived via the external circuit react to generate water.

A DC-DC converter 8 is connected to an output terminal of the fuel cell 4a, and the DC-DC converter 8 is connected to the secondary battery 3 and the inverter 5. By this means, it is possible to utilize the output power of the fuel cell 4a to charge the secondary battery 3 or to drive the motor 2.

Each device (for example, a control valve that controls switching between hydrogen gas and air, or a humidifying apparatus for gas humidification) constituting the fuel cell system 4 for operating the fuel cell 4a as described above are connected to an FC-ECU 9 (fuel cell electronic control unit), and the operating state of the fuel cell 4a is controlled by the FC-ECU 9.

On the other hand, a motor ECU (motor electronic control unit) 10 is connected to the inverter 5, and driving control of the motor 2 is executed by the motor ECU 10. For example, on one hand the motor ECU 10 drivingly controls the inverter 5 to drive the motor 2 by means of output power supplied from the secondary battery 3 or the fuel cell 4a, and on the other hand, during regenerative control of the motor 2, the motor ECU 10 supplies regenerated electric power to the secondary battery 3.

Further, a battery ECU (battery electronic control unit) 11 is connected to the secondary battery 3. Charge/discharge control of the secondary battery 3 is executed by the battery ECU 11, and the battery ECU 11 also calculates the SOC (state of charge) of the secondary battery 3 and the like.

The aforementioned FC-ECU 9, motor ECU 10 and battery ECU 11 are connected to a vehicle ECU 13 (vehicle electronic control unit) that corresponds to a superordinate unit, and the respective ECUs 9 to 11 and 13 each include an input/output device, storage devices (ROM, RAM, nonvolatile RAM or the like) and a central processing unit (CPU). The nonvolatile RAM of each storage device stores commands for various kinds of control, described later, that the respective CPUs perform.

The vehicle ECU 13 is a control unit for performing overall control of the electrically driven vehicle 1. Operation control of the fuel cell 4a, driving control of the motor 2 and charging control of the secondary battery 3 and the like that are described above are executed by the respective subordinate ECUs 9 to 11 which receive commands from the vehicle ECU 13.

Therefore, sensors such as an accelerator sensor 14 that detects an accelerator opening degree APS, and also the FC-ECU 9, the motor ECU 10 and the battery ECU 11 are connected to an input side of the vehicle ECU 13, and detected information such as an accelerator opening degree APS as well as operating information of each of the fuel cell system 4, the motor 2 and the secondary battery 3, for example, a temperature Tfc of the fuel cell 4a, a temperature Tb of the secondary battery 3 and a temperature Tc of a battery charger 31 that is described later and the like are input to the vehicle ECU 13.

The vehicle ECU 13 calculates a required output that is necessary for travel of the electrically driven vehicle 1 based on the accelerator opening degree APS detected by the accelerator sensor 14 and the like, and outputs a command signal to the motor ECU 10 so as to achieve the required output. Based on the command signal, the motor 2 is driven by the motor ECU 10 and the required torque is achieved.

Further, the vehicle ECU 13 calculates the output power of the fuel cell system 4 based on the SOC of the secondary battery 3 and the required output for vehicle travel, and outputs a command signal to the FC-ECU 9 so as to achieve the output power. For example, in a case where the SOC of the secondary battery 3 has decreased and charging is required, or in a case where it is determined that it is impossible for the motor 2 to achieve the required output using only the electric power supply from the secondary battery 3, the vehicle ECU 13 sets the output power of the fuel cell 4a to an increase side.

The FC-ECU 9 calculates the hydrogen gas amount to be supplied to the fuel electrode and the air amount to be supplied to the air electrode in order to achieve the output power, and achieves the required output power by adjusting the calculated gas supply amounts. Naturally, in parallel with such control of the supply of hydrogen gas and air, optimum control is also performed in relation to the humidity of the hydrogen gas and air, the cell pressure and the cell temperature and the like. For example, in a case where the output power is controlled to the increase side as described above, the hydrogen gas amount and air amount are adjusted to the increase side and the output power is increased, and the amount of increase in the electric power is utilized for charging the secondary battery 3 or driving the motor 2.

In this connected, as described above in the “Description of the Related Art” section, because operation of the fuel cell 4a is stopped when charging the secondary battery 3 at a charging station or the like, it is necessary to warm up the fuel cell 4a after restarting the fuel cell 4a, and according to the technology of the aforementioned Patent Literature that performs warming up by means of a vehicle-installed air-conditioning system that utilizes an external power source, in addition to a problem in terms of operating cost, there is also the problem that the start of travel of the vehicle is delayed because the amount of heat is inadequate.

In consideration of this point, the present inventors focused their attention on the fact that heat which the secondary battery 3 generates while charging can be utilized for warming up the fuel cell 4a. That is, by utilizing heat of the secondary battery 3 that would otherwise be wastefully discarded into the atmosphere, operating costs that occur in the case of utilizing an external power source do not arise and the secondary battery 3 also generates a large amount of heat while charging. Furthermore, because warming up of the fuel cell 4a can be carried out concurrently with charging of the secondary battery 3, the electrically driven vehicle 1 can start travelling immediately upon the completion of charging of the secondary battery 3.

The process for warming up the fuel cell 4a that utilizes heat which the secondary battery 3 generates during charging based on these findings is described below. However, before describing that process, the circuitry for transferring heat of the secondary battery 3 to the fuel cell 4a will be described.

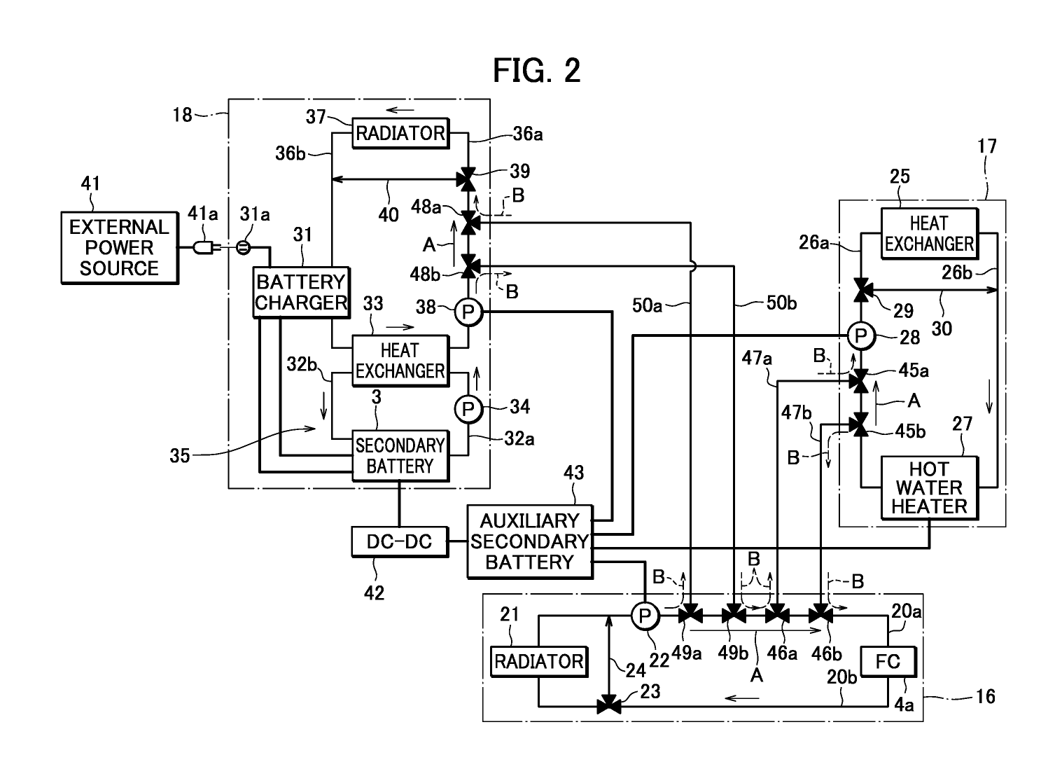

FIG. 2 is a circuit diagram illustrating circuitry for performing warming up of the fuel cell 4a.

The circuitry illustrated in FIG. 2 can be broadly divided into a fuel cell cooling circuit 16 (hereunder, referred to as “FC cooling circuit”) for maintaining the fuel cell 4a at the rated temperature, a hot water circuit 17 for heating the inside of the vehicle cabin, a secondary battery cooling circuit 18 (hereunder, referred to as “charging auxiliary machine cooling circuit”) that cools the secondary battery 3, and an electrical system for charging the secondary battery 3 and supplying electric power to each circuit.

First, the FC cooling circuit 16 will be described. In the FC cooling circuit 16, a radiator 21 is connected through a pair of cooling lines 20a and 20b to the fuel cell 4a. A pump 22 is installed on the cooling line 20a as one of the cooling lines 20a and 20b. As a result, the annular FC cooling circuit 16 that includes the fuel cell 4a, the other cooling line 20b, the radiator 21 and the one cooling line 20a (and pump 22) is formed, and water (coolant) that is sealed in the FC cooling circuit 16 circulates by driving of the pump 22.

A switching valve 23 that is installed on the other cooling line 20b is connected to the one cooling line 20a through a bypass passage 24, and water circulates through or bypasses the radiator 21 in accordance with switching of the switching valve 23. The water temperature is adjusted by means of switching control of the switching valve 23 and flow control of the pump 22 and the like to keep the fuel cell 4a at a predetermined rated temperature during operation.

Next, the hot water circuit 17 that is used for heating the vehicle cabin will be described. In the hot water circuit 17, a heat exchanger 25 that is disposed inside an unshown vehicle cabin is connected to a hot water heater 27 through a pair of hot water lines 26a and 26b, and a pump 28 is installed on the hot water line 26a as one of the pair of hot water lines. As a result, the annular hot water circuit 17 that includes the other hot water line 26b, the hot water heater 27 and the one hot water line 26a (and pump 28) is formed, and water (coolant) that is sealed in the hot water circuit 17 circulates by driving of the pump 28.

A switching valve 29 that is installed on the one hot water line 26a is connected to the other hot water line 26b through a bypass passage 30, and water circulates through or bypasses the heat exchanger 25 in accordance with switching of the switching valve 29. When the hot water heater 27 is turned on and hot water that was heated thereby circulates through the heat exchanger 25, air that was warmed by passing through fins of the heat exchanger 25 as a result of being blown by an unshown fan is supplied into the vehicle cabin and the vehicle cabin is heated.

Next, the charging auxiliary machine cooling circuit 18 (including a back-up cooling circuit 35 that is described below) will be described. In the present embodiment, the secondary battery 3 and the battery charger 31 are cooled by the cooling circuit 18 as a charging auxiliary machine. A heat exchanger 33 is connected through a pair of cooling lines 32a and 32b to the secondary battery 3. A pump 34 is installed on the cooling line 32a as one of the cooling lines 32a and 32b. As a result, the annular back-up cooling circuit 35 that includes the secondary battery 3, the one cooling line 32a (and pump 34), the heat exchanger 33 and the other cooling line 32b is formed, and a dielectric fluid that is sealed in the back-up cooling circuit 35 circulates by driving of the pump 34.

The heat exchanger 33 is connected to a radiator 37 (heat radiator) through the pair of cooling lines 36a and 36b. A pump 38 is installed on the one cooling line 36a, and the battery charger 31 is installed on the other cooling line 36b. As a result, the annular charging auxiliary machine cooling circuit 18 that includes the heat exchanger 33, the one cooling line 36a (and pump 38), the radiator 37 and the other cooling line 36b (and battery charger 31) is formed, and water (coolant) that is sealed in the charging auxiliary machine cooling circuit 18 circulates by driving of the pump 38. A switching valve 39 that is installed on the one cooling line 36a is connected to the other cooling line 36b through a bypass passage 40, and water circulates through or bypasses the radiator 37 in accordance with switching of the switching valve 39.

The dielectric fluid in the back-up cooling circuit 35 is heated by heat that the secondary battery 3 generates during charging and is transferred to the heat exchanger 33. Water that circulates through the charging auxiliary machine cooling circuit 18 is heated by heat exchange with the dielectric fluid at the heat exchanger 33, and is also heated by heat generated at the battery charger 31, and thereafter is radiated by the radiator 37. By repeating the above described process, the secondary battery 3 and the battery charger 31 are cooled and an increase in the temperature of the secondary battery 3 and the battery charger 31 is suppressed. Note that the reason for cooling the secondary battery 3 by means of dielectric fluid in the back-up cooling circuit 35 is to prevent the occurrence of trouble such as electrification if a water leakage occurs.

Next, the electrical system will be described. The secondary battery 3 and the battery charger 31 are electrically connected, and a charging socket 31a is provided in the battery charger 31. Charging of the secondary battery 3 is performed at a charging station or the like. By connecting a charging plug 41a of an external power source 41 provided at the charging station to the charging socket 31a, alternating current electric power from the external power source 41 is converted to direct current electric power by the battery charger 31 and the direct current electric power is used to charge the secondary battery 3. A low-voltage auxiliary secondary battery 43 that is used for auxiliary machine driving is connected through a DC-DC converter 42 to the secondary battery 3.

Electric power from the secondary battery 3 is converted to a lower voltage by the DC-DC converter 42 and used to charge the auxiliary secondary battery 43 as appropriate. By this means the auxiliary secondary battery 43 is maintained at a predetermined SOC. The auxiliary secondary battery 43 is electrically connected to auxiliary machines such as the pumps 22, 28, 34 and 38 of the respective circuits 16 to 18 and 35 and the hot water heater 27, and is configured to supply electric power that is required for the operations of these auxiliary machines. Note that although the auxiliary secondary battery 43 also supplies electric power to other auxiliary machines, a description of those auxiliary machines is omitted as it is not related to the gist of the present invention.

In order to utilize the heat of the hot water circuit 17 and the charging auxiliary machine cooling circuit 18, configured as described above, to warm up the fuel cell 4a, the hot water circuit 17 and the charging auxiliary machine cooling circuit 18 are connected to the FC cooling circuit 16 through connection passages 47a, 47b, 50a and 50b that are described below.

A pair of switching valves 45a and 45b are installed on the one hot water line 26a of the hot water circuit 17. The switching valves 45a and 45b are connected through connection passages 47a and 47b to a pair of switching valves 46a and 46b that are installed on the one cooling line 20a of the FC cooling circuit 16. Similarly, a pair of switching valves 48a and 48b are installed on the one cooling line 36a of the charging auxiliary machine cooling circuit 18. The switching valves 48a and 48b are connected through connection passages -50a and 50b to a pair of switching valves 49a and 49b that are installed on the one cooling line 20a of the FC cooling circuit 16.

During normal operation, the respective switching valves 45a, 45b, 46a, 46b, 48a, 48b, 49a and 49b are switched in a direction that allows circulation of water in the cooling lines 20a and 36a and the hot water line 26a, and the hot water circuit 17 and the charging auxiliary machine cooling circuit 18 are disconnected from the FC cooling circuit 16 (non-communicating state). By this means, at the respective switching valves 45a, 45b, 46a, 46b, 48a, 48b, 49a and 49b, water circulates in the direction of the arrows A in the drawing, and circulation of hot water in the hot water circuit 17 for heating, or circulation of water in the charging auxiliary machine cooling circuit 18 for cooling the secondary battery 3 and the battery charger 31 is performed. Hereunder, the switching state of the respective switching valves 45a, 45b, 46a, 46b, 48a, 48b, 49a and 49b at such time is described as the “A side”.

Further, when the respective switching valves 45a, 45b, 46a, 46b, 48a, 48b, 49a and 49b are switched from the A side to the connection passages 47a, 47b, 50a and 50b side, the hot water circuit 17 and the charging auxiliary machine cooling circuit 18 communicate with the FC cooling circuit 16 through the connection passages 47a, 47b, 50a and 50b to form a single large circuit.

For example, when the respective switching valves 45a and 45b of the hot water circuit 17 and the corresponding switching valves 46a and 46b of the FC cooling circuit 16 are switched to the connection passages 47a and 47b side, water circulates in the direction of the arrows B in the drawing. Water that is discharged from the pump 22 of the FC cooling circuit 16 is transferred to the hot water circuit 17 through the switching valve 46a, the connection passage 47a and the switching valve 45a, and after circulating through or bypassing the heat exchanger 25 from the pump 28 and being heated by the hot water heater 27, the resultant hot water is returned to the FC cooling circuit 16 through the switching valve 45b, the connection passage 47b and the switching valve 46b, and flows through the fuel cell 4a to raise the temperature thereof.

Note that, at this time the pump 28 of the hot water circuit 17 may be actuated, or may be left in a stopped state as long as the pump 28 does not hinder the flow of the hot water. Further, in the case of actuating the pump 28 of the hot water circuit 17, the pump 22 of the FC cooling circuit 16 may be stopped.

Similarly, when the respective switching valves 48a and 48b of the charging auxiliary machine cooling circuit 18 and the corresponding switching valves 49a and 49b of the FC cooling circuit 16 are switched to the connection passages 50a and 50b side, water circulates in the direction of the arrows B in the drawing. Water that is discharged from the pump 22 of the FC cooling circuit 16 is transferred to the charging auxiliary machine cooling circuit 18 through the switching valve 49a, the connection passage 50a and the switching valve 48a, and circulates through or bypasses the radiator 37 and is heated by the battery charger 31, and is further heated by the heat exchanger 33, and thereafter the resultant hot water is returned to the FC cooling circuit 16 through the switching valve 48b, the connection passage 50b and the switching valve 49b from the pump 34, and flows through the fuel cell 4a to raise the temperature thereof. The switching state of the respective switching valves 45a, 45b, 46a, 46b, 48a, 48b, 49a and 49b when switched to the side of the connection passages 47a, 47b, 50a and 50b as described above is described as the “B side”.

Note that, at this time the pump 38 of the charging auxiliary machine cooling circuit 18 may be actuated, or may be left in a stopped state as long as the pump 38 does not hinder the flow of water. Further, in the case of actuating the pump 38 of the charging auxiliary machine cooling circuit 18, the pump 22 of the FC cooling circuit 16 may be stopped.

Next, processing for warm up the fuel cell 4a that is executed by the vehicle ECU 13 utilizing the above described circuitry is described.

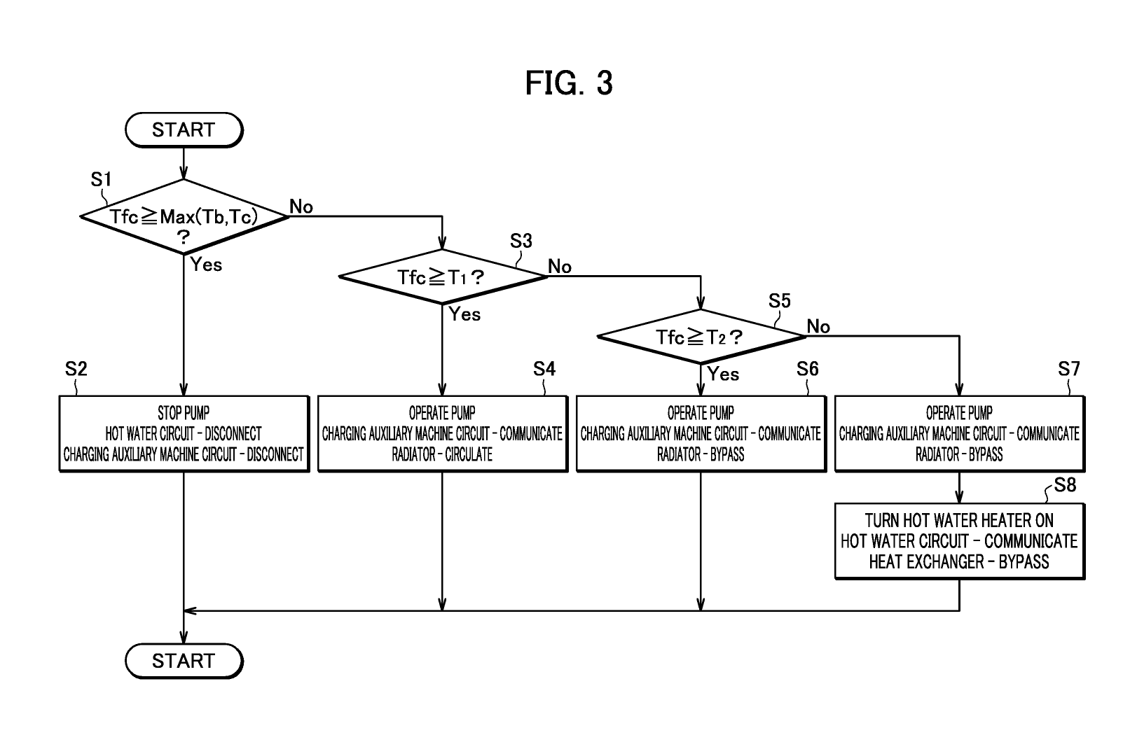

FIG. 3 is a flowchart illustrating a warm-up control routine that the vehicle ECU 13 executes. This routine is executed at predetermined control intervals during charging of the secondary battery 3.

First, in step S1, the vehicle ECU 13 determines whether or not the temperature Tfc of the fuel cell 4a is equal to or higher than a higher side of the temperature Tb of the secondary battery 3 and the temperature Tc of the battery charger. If the result of the determination in step S1 is “Yes” (affirmative), in step S2 the vehicle ECU 13 maintains the pump 22 of the FC cooling circuit 16 in a stopped state (the pump 22 already stopped when the FC stopped), and also switches all of the switching valves 45a, 45b, 46a, 46b, 48a, 48b, 49a and 49b to the A side to disconnect both the hot water circuit 17 and the charging auxiliary machine cooling circuit 18 from the FC cooling circuit 16. Since when charging starts initially, neither the secondary battery 3 nor the battery charger 31 generate much heat and the water that circulates through the charging auxiliary machine cooling circuit 18 is also at a low temperature, this processing is performed to avoid the occurrence of a situation in which, on the contrary, the temperature of the fuel cell 4a is reduced by allowing the charging auxiliary machine cooling circuit 18 to communicate with the FC cooling circuit 16.

Note that, because the FC cooling circuit 16 and the charging auxiliary machine cooling circuit 18 exchange heat using water as a medium, a configuration may also be adopted in which the temperature of water in the FC cooling circuit 16 is used instead of the temperature Tfc of the fuel cell 4a, and the temperature of water in the charging auxiliary machine cooling circuit 18 is used instead of the temperatures Tb and Tc of the secondary battery 3 and the battery charger 31. The temperature of the fuel cell 4a of the present invention shall be taken to also include the water temperature in the FC cooling circuit 16, and the temperature of the secondary battery 3 of the present invention shall be taken to also include the water temperature in the charging auxiliary machine cooling circuit 18.

When the respective temperatures Tb and Tc of the secondary battery 3 and the battery charger 31 gradually rise accompanying charging and the result of the determination in step S1 becomes “No” (negative), it is determined that the fuel cell 4a can be warmed up utilizing heat from the secondary battery 3 and the battery charger 31, and hence the processing transitions to step S3 in which the vehicle ECU 13 determines whether or not the temperature Tfc of the fuel cell 4a is equal to or higher than a first determination value T1 that is set in advance. If the result of the determination in step S3 is “Yes”, the processing transitions to step S4 in which the vehicle ECU 13 starts operation of the pump 22 of the FC cooling circuit 16 and then switches the respective switching valves 48a and 48b of the charging auxiliary machine cooling circuit 18 and each of the corresponding switching valves 49a and 49b of the FC cooling circuit 16 to the B side. By this means, the charging auxiliary machine cooling circuit 18 communicates with the FC cooling circuit 16 through the connection passages 50a and 50b. Simultaneously, the vehicle ECU 13 switches the switching valve 39 so that water in the charging auxiliary machine cooling circuit 18 circulates through the radiator 37.

Because the first determination value T1 is set to a temperature that is high to a certain extent, for example, 30° C., it is considered that in this case it is not so necessary to warm up the fuel cell 4a as quickly as possible. Hence, first the fuel cell 4a is warmed up by means of only heat generated at the charging auxiliary machine cooling circuit 18, and an increase in the temperature of the water is suppressed to a moderate degree by releasing heat at the radiator 37 to thereby protect the secondary battery 3 and the battery charger 31.

When the result of the determination in step S3 is “No”, the processing transitions to step S5 in which the vehicle ECU 13 determines whether or not the temperature Tfc of the fuel cell 4a is equal to or greater than a second determination value T2 (<T1) that is set in advance. If the result of the determination in step S5 is “Yes”, the processing transitions to step S6. In step S6, the vehicle ECU 13 starts operation of the pump 22 of the FC cooling circuit 16 and then switches the respective switching valves 48a and 48b of the charging auxiliary machine cooling circuit 18 and each of the corresponding switching valves 49a and 49b of the FC cooling circuit 16 to the B side, and also switches the switching valve 39 so that the water circulating through the charging auxiliary machine cooling circuit 18 bypasses the radiator 37.

Because the second determination value T2 is set to a comparatively low temperature, for example, 5° C., it is considered that in this case, to a certain extent it is necessary to warm up the fuel cell 4a as rapidly soon as possible. Similarly to the case in step S4 that is described above, the fuel cell 4a is warmed up by means of only heat generated at the charging auxiliary machine cooling circuit 18, but in this case, warming up of the fuel cell 4a is further accelerated because the release of heat from the radiator 37 is stopped.

When executing the processing in the above described steps S1 to 7, the vehicle ECU 13 functions as a warm-up control unit of the present invention.

Further, when the result of the determination in step S5 is “No”, the processing transitions to step S7 in which, similarly to step S6, the vehicle ECU 13 starts operation of the pump 22 of the FC cooling circuit 16 and then switches the respective switching valves 48a and 48b of the charging auxiliary machine cooling circuit 18 and each of the corresponding switching valves 49a and 49b of the FC cooling circuit 16 to the B side, and also switches the switching valve 39 so that the water circulating through the charging auxiliary machine cooling circuit 18 bypasses the radiator 37. Subsequently, in step S8, the vehicle ECU 13 turns on the hot water heater 27 and then switches the respective switching valves 45a and 45b of the hot water circuit 17 and each of the corresponding switching valves 46a and 46b of the FC cooling circuit 16 to the B side, and also switches the switching valve 29 so that the water circulating through the hot water circuit 17 bypasses the heat exchanger 25.

By this means, both the hot water circuit 17 and the charging auxiliary machine cooling circuit 18 communicate with the FC cooling circuit 16 through the connection passages 47a, 47b, 50a and 50b, and the release of heat by the heat exchanger 25 and the radiator 37 in both of the circuits 17 and 18 is stopped. In this case, it is necessary to warm up the fuel cell 4a as quickly as possible since the temperature Tfc of the fuel cell 4a is less than the first determination value T1, and because all of the heat generated in both the hot water circuit 17 and the charging auxiliary machine cooling circuit 18 is not released at the heat exchanger 25 and the radiator 37 and therefore is utilized without waste to warm up the fuel cell 4a, the fuel cell 4a is rapidly warmed up.

In a case such as this in which it is possible to warm up the fuel cell 4a with heat of the secondary battery 3 and the battery charger 31 at an initial stage after starting charging of the secondary battery 3, the fuel cell 4a is warmed up by the processing in any of step S4, step S6 and steps S7 and S8 in accordance with the temperature Tfc of the fuel cell 4a. Further, when warming up of the fuel cell 4a progresses and the temperature Tfc rises, the processing switches from steps S7 and S8 to step S6, and furthermore to step S4. According to the specifications of the secondary battery 3 and the battery charger 31 of the present embodiment, it is possible to raise the temperature of the fuel cell 4a as far as the rated temperature by utilizing heat generated during charging, and an equilibrium state is entered at the rated temperature and an increase in the temperature is suppressed. Hence, warming up of the fuel cell 4a is completed during execution of the processing in step S4 and the temperature of the fuel cell 4a at that time point is maintained, and charging of the secondary battery 3 ends in that state.

However, the present invention is not limited to the above configuration and, for example, in a case where the fuel cell 4a exceeds the rated temperature as a result of being heated with only heat that the secondary battery 3 and the battery charger 31 generate during charging, a configuration may be adopted so as to end warming up of the fuel cell 4a at an upper limit temperature that is set in advance.

As described in detail above, according to the warm-up apparatus of the fuel cell 4a for an electrically driven vehicle of the present embodiment, the fuel cell 4a is warmed up by heat that the secondary battery 3 and the battery charger 31 generate during charging, and because heat that would be wastefully discarded into the atmosphere is utilized, no operating cost at all is required to perform warming up.

Further, because the secondary battery 3 and the battery charger 31 generate a large amount of heat during charging, fundamentally the fuel cell 4a can be adequately warmed up rapidly by only the process in step S4 or step S6. In this respect, the process that utilizes the heat of the hot water circuit 17 in step S8 is an auxiliary process and need not necessarily be performed. The fuel cell 4a can be rapidly warmed up utilizing a large amount of heat that the secondary battery 3 and the battery charger 31 generate in this way, and furthermore the warming up at this time is executed concurrently with charging of the secondary battery 3. Hence, warming up of the fuel cell 4a can be completed during charging of the secondary battery 3, and consequently the electrically driven vehicle 1 can start to travel immediately upon the completion of charging of the secondary battery 3.

Note that, in particular the secondary battery 3 generates a larger amount of heat than the battery charger 31, and therefore a configuration may also be adopted so as to warm up the fuel cell 4a using only the heat of the secondary battery 3 during charging. In such a case, the battery charger 31 can be bypassed or can be excluded from the charging auxiliary machine cooling circuit 18.

Further, the existing pump 22 that is provided in the FC cooling circuit 16 is utilized to transfer water between the charging auxiliary machine cooling circuit 18 or the hot water circuit 17 and the FC cooling circuit 16 through the connection passages 47a, 47b, 50a and 50b. Therefore, water that is heated in the charging auxiliary machine cooling circuit 18 or the hot water circuit 17 can be quickly and reliably guided to the FC cooling circuit 16, and this is also a factor that contributes to rapid completion of warming up.

However, the pump 22 is not necessarily required, and a configuration may also be adopted in which the charging auxiliary machine cooling circuit 18 or the hot water circuit 17 and the FC cooling circuit 16 are caused to communicate through the connection passages 47a, 47b, 50a and 50b by switching the switching valves 45a, 45b, 46a, 46b, 48a, 48b, 49a and 49b to the B side, and then the water is transferred by utilizing natural convection. In particular, in a layout in which the FC cooling circuit 16 is arranged immediately above the charging auxiliary machine cooling circuit 18 or the hot water circuit 17, since the heated water will be transferred by natural convection to the FC cooling circuit 16 that is above the charging auxiliary machine cooling circuit 18 or the hot water circuit 17, the fuel cell 4a can be adequately warmed up even without a pump.

Further, when the respective temperatures Tb and Tc of the secondary battery 3 and the battery charger 31 rise as a result of charging and a time point is reached when either of the temperatures Tb and Tc becomes equal to or higher than the temperature Tfc of the fuel cell 4a, at that time point the operation of the pump 22 of the FC cooling circuit 16 is started and, furthermore, the charging auxiliary machine cooling circuit 18 is caused to communicate with the FC cooling circuit 16 through the connection passages 50a and 50b. Hence, a situation can be avoided in which, when charging initially starts, water having a low temperature is transferred to the FC cooling circuit 16 and lowers the temperature of the fuel cell 4a, and thus more efficient warming up of the fuel cell 4a can be realized.

Further, the secondary battery 3 is cooled by dielectric fluid in the back-up cooling circuit 35, and the dielectric fluid exchanges heat with water in the charging auxiliary machine cooling circuit 18 through the heat exchanger 33. Accordingly, the occurrence of trouble such as electrification if a water leakage occurs can be prevented, and even in this form of fuel cell system it is possible to realize warming up of the fuel cell 4a that utilizes the heat of the secondary battery 3 and the battery charger 31.

Further, when the temperature Tfc of the fuel cell 4a is equal to or higher than the first determination value T1, water in the charging auxiliary machine cooling circuit 18 is circulated to the radiator 37, and when the temperature Tfc of the fuel cell 4a is less than the first determination value T1, the water is caused to bypass the radiator 37. When water is circulated to the radiator 37, a rise in the temperature of the secondary battery 3 and the battery charger 31 is suppressed and the secondary battery 3 and the battery charger 31 can be reliably protected, and when the water bypasses the radiator 37, warming up of the fuel cell 4a can be further accelerated, and therefore warm-up control whose contents are the optimal contents according to the temperature of the fuel cell 4a at the relevant time point can be executed.

While an embodiment of the present invention has been described above, it is to be noted that aspects of the present invention are not limited to the foregoing embodiment. For example, although in the above described embodiment the heat of the hot water circuit 17 is also utilized for warming up the fuel cell 4a, and not just heat that the secondary battery 3 and the battery charger 31 generate in the charging auxiliary machine cooling circuit 18, the heat of the hot water circuit 17 need not be utilized.

Further, although in the above described embodiment a configuration is adopted that cools the secondary battery 3 using dielectric fluid, instead of this configuration, a configuration may be adopted so as to directly cool the secondary battery 3 with water in the charging auxiliary machine cooling circuit 18.

What is claimed is:

1. A warm-up apparatus for a fuel cell for a vehicle in which a fuel cell and a secondary battery are mounted as power sources of a motor for travelling, and which, when charging of the secondary battery is required, stops operation of the fuel cell and charges the secondary battery with electric power from an external power source by means of a battery charger, comprising:
a secondary battery cooling circuit that cools the secondary battery;
a fuel cell cooling circuit that cools the fuel cell;
a connection passage that connects the secondary battery cooling circuit and the fuel cell cooling circuit through a switching valve; and
a warm-up control unit that, during charging of the secondary battery, controls the switching valve so that the secondary battery cooling circuit and the fuel cell cooling circuit communicate through the connection passage.

2. The warm-up apparatus for a fuel cell for a vehicle according to claim 1, wherein the secondary battery cooling circuit also cools the battery charger together with the secondary battery.

3. The warm-up apparatus for a fuel cell for a vehicle according to claim 1, wherein when a temperature of the secondary battery rises accompanying charging of the secondary battery and becomes equal to or higher than a temperature of the fuel cell, the warm-up control unit controls the switching valve so that the secondary battery cooling circuit and the fuel cell cooling circuit communicate through the connection passage.

4. The warm-up apparatus for a fuel cell for a vehicle according to claim 1, comprising a pump that, during charging of the secondary battery, circulates a coolant between the secondary battery cooling circuit and the fuel cell cooling circuit through the connection passage.

5. The warm-up apparatus for a fuel cell for a vehicle according to claim 4, wherein the warm-up control unit starts operation of the pump at a time that a temperature of the secondary battery rises accompanying charging of the secondary battery and becomes equal to or higher than a temperature of the fuel cell.

6. The warm-up apparatus for a fuel cell for a vehicle according to claim 1, wherein water as a coolant is sealed in the secondary battery cooling circuit, the fuel cell cooling circuit and the connection passage, respectively, the secondary battery is cooled by dielectric fluid, and heat is exchanged between the dielectric fluid and water in the secondary battery cooling circuit through a heat exchanger.

7. The warm-up apparatus for a fuel cell for a vehicle according to claim 1, wherein:
a radiator is provided as an accessory in the secondary battery cooling circuit; and
when a temperature of the fuel cell is equal to or higher than a predetermined temperature, the warm-up control unit circulates the coolant in the secondary battery cooling circuit to the radiator, and when the temperature of the fuel cell is less than a predetermined temperature, the warm-up control unit causes the coolant in the secondary battery cooling circuit to bypass the radiator.

8. A warm-up apparatus for a fuel cell for a vehicle in which a fuel cell and a secondary battery are mounted as power sources of a motor for travelling, and which, when charging of the secondary battery is required, stops operation of the fuel cell and charges the secondary battery with electric power from an external power source by means of a battery charger, comprising:
a secondary battery cooling circuit that cools the secondary battery;
a fuel cell cooling circuit that cools the fuel cell;
a connection passage that connects the secondary battery cooling circuit and the fuel cell cooling circuit through a switching valve;
a pump that circulates a coolant between the secondary battery cooling circuit and the fuel cell cooling circuit through the connection passage; and
a warm-up control unit that, when a temperature of the secondary battery rises accompanying charging of the secondary battery and becomes equal to or higher than a temperature of the fuel cell, controls the switching valve so that the secondary battery cooling circuit and the fuel cell cooling circuit communicate through the connection passage and also starts operation of the pump.

9. A warm-up apparatus for a fuel cell for a vehicle in which a fuel cell and a secondary battery are mounted as power sources of a motor for travelling, and which, when charging of the secondary battery is required, stops operation of the fuel cell and charges the secondary battery with electric power from an external power source by means of a battery charger, comprising:
a secondary battery cooling circuit that cools the secondary battery;
a fuel cell cooling circuit that cools the fuel cell;
a connection passage that connects the secondary battery cooling circuit and the fuel cell cooling circuit through a switching valve;
a radiator that is provided as an accessory in the secondary battery cooling circuit; and
a warm-up control unit that, when a temperature of the secondary battery rises accompanying charging of the secondary battery and becomes equal to or higher than a temperature of the fuel cell, controls the switching valve so that the secondary battery cooling circuit and the fuel cell cooling circuit communicate through the connection passage, and when a temperature of the fuel cell is equal to or higher than a predetermined temperature, circulates the coolant in the secondary battery cooling circuit to the radiator, and when the temperature of the fuel cell is less than a predetermined temperature, causes the coolant in the secondary battery cooling circuit to bypass the radiator.

10. The warm-up apparatus for a fuel cell for a vehicle according to claim 8, wherein:
a radiator is provided as an accessory in the secondary battery cooling circuit; and
when a temperature of the fuel cell is equal to or higher than a predetermined temperature, the warm-up control unit circulates a coolant in the secondary battery cooling circuit to the radiator, and when the temperature of the fuel cell is less than a predetermined temperature, the warm-up control unit causes the coolant in the secondary battery cooling circuit to bypass the radiator.
